(19) United States
(12) Patent Application Publication
(10) Pub. No.: US 2010/0179830 A1
(43) Pub. Date: Jul. 15, 2010

(54) METHODS AND SYSTEM TO MONITOR MEDICATION IN A HEALTHCARE FACILITY

(76) Inventor: Hanif G. Bagwandeen, Boston, MA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/353,535

(22) Filed: Jan. 14, 2009

(51) Int. Cl. G06Q 50/00; G06F 17/00

(52) U.S. Cl. 705/3; 700/242; 705/2

(57) ABSTRACT

Methods and system to monitor medication in a healthcare facility are described. An example computer-implemented method to monitor an amount of medication administered includes automatically identifying an actual amount of the medication in a container prior to administering the medication. Additionally, the method includes automatically identifying the actual amount of the medication in the container after administering the medication. Further, the method includes determining a difference between the amount of the medication prior to administering the medication and after administering the medication, wherein the difference is associated with the amount of the medication administered to a particular patient. Further still, the method includes associating the amount of the medication administered with a patient medical record.

### BACKGROUND

When administering medications in healthcare environments, such as hospitals and clinics, known practices rely on the healthcare practitioners to ensure that the amount of medication obtained is the amount received by the particular patient. As a result, patients may receive inaccurate amounts of a particular medication (e.g., too much or too little) and/or some medication may go unaccounted for.

Additionally, to monitor when and how much of a particular medication is administered, known practices rely heavily on handwritten notes that are attached to a patient's physical medical report and later manually entered into the patient's electronic medical record by a healthcare practitioner. Such known practices are prone to incompleteness and/or inaccuracies because the data related to the administered medication is typically entered by the healthcare practitioner after the fact. As a result, in some instances, medications may be administered too frequently or too infrequently and/or a medication may be administered that interacts adversely with other medications that the patient has previously taken.

Further, to monitor the amount of medication within the healthcare facility to ensure that adequate supplies are maintained, known practices require healthcare practitioners to manually verify the amount of medication in each container and reorder the respective medication accordingly. As a result, the overall efficiency of the healthcare practitioner is compromised and the amount of medication in a healthcare facility may be too high or too low.

### SUMMARY

In one example implementation, an example computer-implemented method to monitor an amount of medication administered includes automatically identifying an actual amount of the medication in a container prior to administering the medication. Additionally, the method includes automatically identifying the actual amount of the medication in the container after administering the medication. Further, the method includes determining a difference between the amount of the medication prior to administering the medication and after administering the medication. The difference is associated with the amount of the medication administered to a particular patient. Further still, the method includes associating the amount of the medication administered with a patient medical record.

In another example implementation, an example apparatus for use with a medical information system to monitor an amount of medication administered includes a housing defining a plurality of slots that are each to receive a container containing medication. Additionally, the example apparatus includes a first sensor disposed in each of the plurality of slots. The first sensor is associated with determining an amount of medication in the respective container. Further, the example apparatus includes a second sensor adjacent each of the plurality of slots to obtain information associated with the respective container.

### BRIEF DESCRIPTION OF THE DRAWINGS

FIG. 1 is a block diagram of an example medical information system.

FIG. 2 is a block diagram of an example apparatus that may be used to implement at least one of the example medication monitoring units of FIG. 1.

FIG. 3 is an example apparatus that may be used to implement at least one of the example medication monitoring units of FIG. 1.

FIGS. 4, 5 and 6 are flow diagrams representative of example machine readable instructions that may be executed to implement the example medication monitoring unit of FIGS. 1, 2 and 3.

FIG. 7 is a block diagram of an example processor system that may be used to execute the machine readable instructions of FIGS. 4, 5 and 6 to implement the example medication monitoring unit of FIGS. 1, 2 and 3.

The foregoing summary, as well as the following detailed description of certain example implementations, will be better understood when read in conjunction with the appended drawings. For the purpose of illustrating the example methods and systems described herein, certain implementations are shown in the drawings. It should be understood, however, that the example methods and systems are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The examples described herein enable healthcare facilities to more accurately monitor medications. In particular, the examples described herein monitor the amount of administered medication by weighing a container prior to and after the medication is administered. Once identified, the actual amount of administered medication may be displayed to a healthcare practitioner for verification and/or associated with a corresponding medical report and/or history. Such an approach enables healthcare practitioners to decrease the amount of data entry performed in association with administering medication while, at the same time, increasing the accuracy and completeness of the corresponding medical reports. Additionally, such an approach enables healthcare facilities to more accurately account for all medication.

Additionally, the examples described herein identify characteristics of the medication being administered, which then may be displayed to a healthcare practitioner for verification. Some of these characteristics may be associated drug interaction information based on the patient's medical record and/or history. Identifying characteristics of the administered medication decreases the likelihood that critical information is missed or mistakenly overlooked and, thus, the quality of delivered patient care is increased.

Further, to ensure that adequate quantities of medication are maintained onsite, the examples described herein identify and convey when the amount of medication in a container is at or below a predetermined level. In particular, the examples described herein may prompt a healthcare practitioner to reorder the medication, automatically reorder the medication and/or add the medication to a list of medications to be reordered.

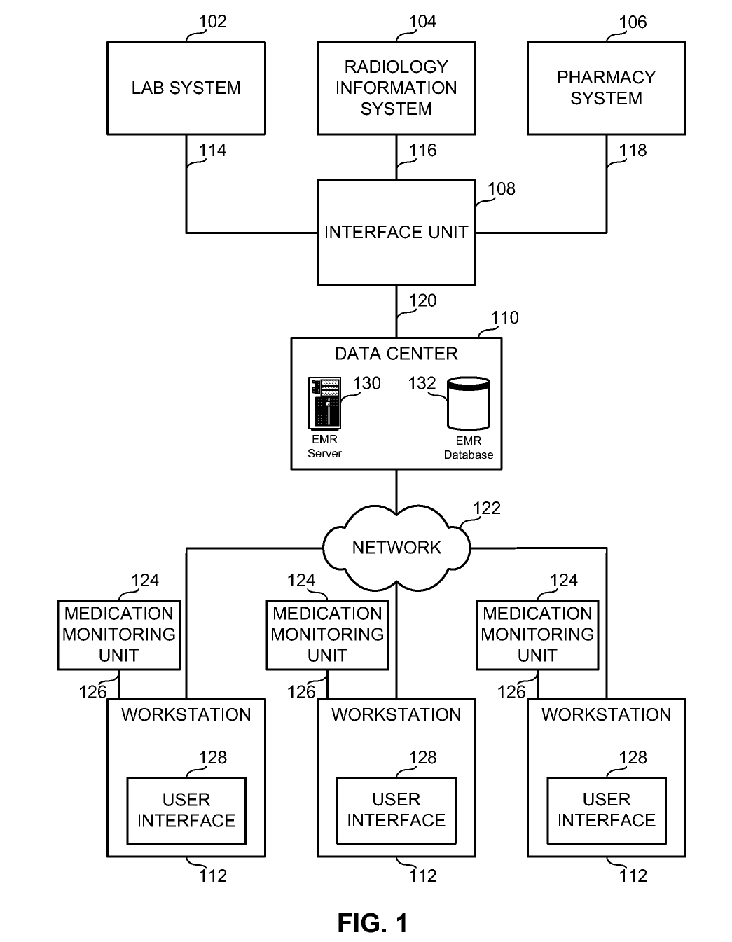

FIG. 1 is a block diagram of an example medical information system 100 capable of implementing the example methods and apparatus described herein to monitor medication in a healthcare facility. The medical information system 100 includes a lab system 102, a radiology information system 104 and a pharmacy system 106. Additionally, the medical information system 100 includes an interface unit 108, a data center 110 and a plurality of workstations 112. In the illustrated example, the lab system 102, the radiology information system 104 and the pharmacy system 106 are housed in a healthcare facility and locally archived. However, in other implementations, the lab system 102, the radiology information system 104 and the pharmacy system 106 may be housed in one or more other suitable locations. Furthermore, one or more components of the medical information system 100 may be combined and/or implemented together. For example, the lab system 102 and/or the radiology information system 104 may be integrated with the pharmacy system 106; the radiology information system 104 may be integrated with the pharmacy system 106; and/or the three example information systems 102, 104 and/or 106 may be integrated together. In other example implementations, the medical information system 100 includes a subset of the illustrated information systems 102, 104 and/or 106. For example, the medical information system 100 may include only one or two of the lab system 102, the radiology information system 104 and the pharmacy system 106. Preferably, information (e.g., test results, observations, diagnosis, etc.) is entered into the lab system 102, the radiology information system 104 and the pharmacy system 106 by healthcare practitioners (e.g., radiologists, physicians and/or technicians) before, during and/or after a patient examination and/or encounter.

The lab system 102 receives, stores and/or conveys medical information received from, for example, personnel at a hospital, clinic and/or a physician's office associated with the Clinical Laboratory Department, which includes information related to Anatomic Pathology, Clinical Microbiology, Clinical Biochemistry, Hematology, etc. The radiology information system 104 stores information such as, for example, radiology reports, messages, warnings, alerts, patient scheduling information, patient demographic data, patient tracking information and/or physician and patient status monitors. Additionally, the radiology information system 104 enables exam order entry (e.g., ordering an x-ray of a patient) and image and film tracking (e.g., tracking identities of one or more people that have checked out a film). In some examples, information in the radiology information system 104 is formatted according to the HL-7 (Health Level Seven) clinical communication protocol.

The pharmacy system 106 receives, stores and/or conveys medical information associated with orders for medications. In some examples, the pharmacy system 106 tracks medication orders to completion, generates medical bills associated with the medication dispensed, and monitors and/or controls the inventory in the pharmacy. The pharmacy system 106 interfaces with a number of other systems within the medical information system 100 to receive prescription orders and to generate medical bills associated with the dispensed medication such as, for example, the data center 110 and an insurance system (not shown).

The interface unit 108 includes a lab system interface connection 114, a radiology information system interface connection 116, a pharmacy system interface connection 118 and a data center interface connection 120. The interface unit 108 facilitates communication among the lab system 102, the radiology information system 104, the pharmacy system 106 and/or the data center 110. The interface connections 114, 116, 118, and 120 may be implemented by, for example, a Wide Area Network (WAN) such as a private network or the Internet. Accordingly, the interface unit 108 includes one or more communication components such as, for example, an Ethernet device, an asynchronous transfer mode (ATM) device, an 802.11 device, a DSL modem, a cable modem, a cellular modem, etc. In turn, the data center 110 communicates with the plurality of workstations 112 via a network 122, implemented at a plurality of locations (e.g., a hospital, clinic, doctor's office, other medical office or terminal, etc.). The network 122 is implemented by, for example, the Internet, an intranet, a private network, a wired or wireless Local Area Network and/or a wired or wireless Wide Area Network. In some examples, the interface unit 108 also includes a broker (e.g., a Mitra Imaging's PACS Broker) to allow medical information and medical images to be transmitted together and stored together.

In operation, the interface unit 108 receives images, medical reports, administrative information and/or other clinical information from the information systems 102, 104, 106 via the interface connections 114, 116 and 118. If necessary (e.g., when different formats of the received information are incompatible), the interface unit 108 translates or reformats (e.g., into Structured Query Language (SQL) or standard text) the medical information, such as medical reports, to be properly stored at the data center 110. Preferably, the reformatted medical information may be transmitted using a transmission protocol to enable different medical information to share common identification elements, such as a patient name or a social security number. Next, the interface unit 108 transmits the medical information to the data center 110 via the data center interface connection 120. Finally, medical information is stored in the data center 110.

The medical information is later viewable and easily retrievable at one or more of the workstations 112 (e.g., by their common identification element, such as a patient name or a record number). The workstations 112 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 112 are connected to the network 122 and, thus, can communicate with each other, the data center 110, and/or any other device coupled to the network 122. Additionally, each of the workstations 112 is communicatively coupled to a medication monitoring unit 124 via a medication monitoring unit interface connection 126.

Advantageously, the medication monitoring units 124 enable healthcare practitioners to more quickly and efficiently generate and/or record information related to an actual amount of medication administered to a patient with the associated patient medical report, record and/or history. Specifically, the medication monitoring units 124 enable the amount of medication administered to be monitored by weighing a container containing medication, prior to and after the medication is administered. Once the amount of medication administered is determined, this information is transmitted to the respective workstation 112, via the medication monitoring unit interface connection 126, where it is displayed on a user interface 128 for review and/or conformation by the healthcare practitioner. Additionally, the medication monitoring units 124 may advantageously enable the identification of information related to the medication being administered, which is then transmitted to the respective workstation 112, via the medication monitoring unit interface connection 126, where it is displayed on the user interface 128 for review and/or conformation by the healthcare practitioner. Such an approach decreases the likelihood that critical information is missed or mistakenly overlooked. Further, the medication monitoring units 124 may advantageously monitor the amount of medication in each of the containers and transmit an alert when any of the medications are at or below a predetermined level. In contrast to known medication reordering methods, the medication monitoring units 124 may automatically reorder medication, add medication to a list of medications to be reordered and/or prompt a healthcare practitioner when a medication is at or below a predetermined level, for example. Further still, the medication monitoring units 124 enable the data center 110 to store the data relating to the amount of medication administered within patient medical reports, records and/or histories. Such an approach increases the accuracy and completeness of medical reports, records and/or histories, which enables healthcare practitioner to more accurately monitor the amount and/or types of medication(s) administered and the time at which the respective medication was administered. Additionally, such an approach enables healthcare practitioners to monitor and/or account for the medication(s) within a healthcare facility.

The example data center 110 of FIG. 1 is an archive to store information such as, for example, images, data, medical reports, and/or, more generally, patient medical records. In addition, the data center 110 may also serve as a central conduit to information located at other sources such as, for example, local archives, the lab systems, radiology information systems and/or pharmacy systems (e.g., the lab system 102, the radiology information system 104 and the pharmacy system 106). That is, the data center 110 may store links or indicators (e.g., identification numbers, patient names or record numbers) to information. In the illustrated example, the data center 110 is managed by an application server provider (ASP) and is located in a centralized location that may be accessed by a plurality of systems and facilities (e.g., hospitals, clinics, doctor's offices, other medical offices and/or terminals). In some examples, the data center 110 may be spatially distant from the lab system 102, the radiology information system 104 and the pharmacy system 106 (e.g., at a General Electric® facility).

The example data center 110 of FIG. 1 includes an EMR server 130 and an EMR database 132. The EMR server 130 receives, processes, and conveys information to and from the components of the medical information system 100. The EMR database 132 stores the medical information described herein and provides access thereto.

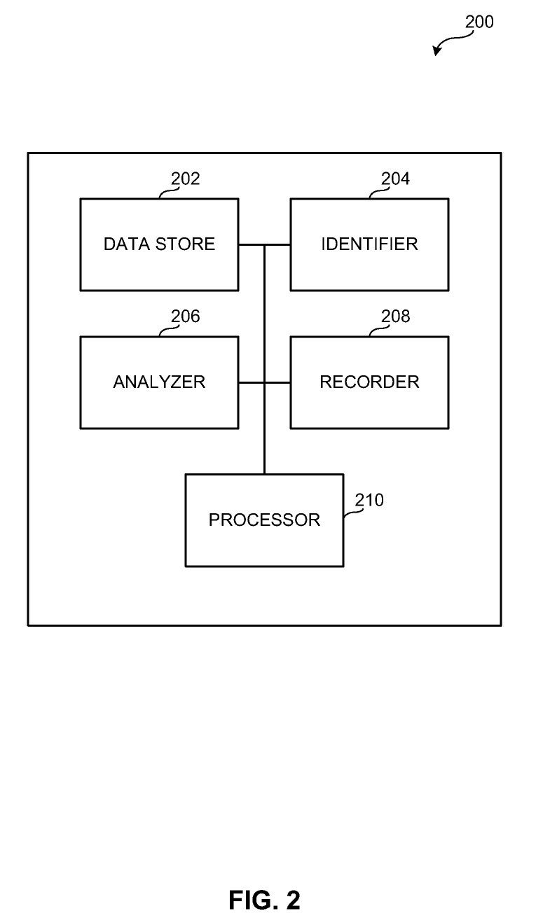

FIG. 2 is a block diagram of an example apparatus 200 that may be used to implement at least one of the medication monitoring units 124 of FIG. 1. In the illustrated example of FIG. 2, the example apparatus 200 includes a data store 202, an identifier 204, an analyzer 206, a recorder 208 and a processor 210. While an example manner of implementing at least one of the medication monitoring units 124 of FIG. 1 has been illustrated in FIG. 2, one or more of the elements, processes and/or devices illustrated in FIG. 2 may be combined, divided, re-arranged, omitted, eliminated and/or implemented in any other way. Further, the data store 202, the identifier 204, the analyzer 206, the recorder 208 and the processor 210 and/or, more generally, the example apparatus 200 of FIG. 2 may be implemented by hardware, software, firmware and/or any combination of hardware, software and/or firmware. Thus, for example, any of the data store 202, the identifier 204, the analyzer 206, the recorder 208 and the processor 210 and/or, more generally, the example apparatus 200 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the data store 202, the identifier 204, the analyzer 206, the recorder 208 and the processor 210 and/or, more generally, the example apparatus 200 of FIG. 2 are hereby expressly defined to include a tangible medium such as a memory, DVD, CD, etc., storing the software and/or firmware. Further still, the example apparatus 200 of FIG. 2 may include one or more elements, processes and/or devices in addition to, or instead of, those illustrated in FIG. 2, and/or may include more than one of any or all of the illustrated elements, processes and devices.

To identify characteristics of and an actual amount of medication in one or more containers, the example apparatus 200 is provided with the identifier 204. In particular, the identifier 204 may identify the actual amount of medication in a container prior to and after the medication is administered. Additionally, the identifier 204 may identify characteristics associated with the medication, which may be, for example, an identity of the medication, an intended dosage of the medication, a dosing interval for the medication and/or medication interaction information. In some examples, the medication interaction information may be associated with other medication(s) that may effect the patient when combined with the medication to be administered. In other examples, the identifier 204 may identify medication(s) in the patient's medical record and/or history the may effect the patient when combined with the medication to be administered. Further, the identifier 204 may identify when the amount of medication in the container is at or below a predetermined level. The identifier 204 may also create a software object to represent the identified characteristics and the actual amount of medication in a particular container.

In practice, the identifier 204 identifies an amount of medication administered based on a determined weight of the container containing the medication. As a healthcare practitioner removes the container to obtain the medication to be administered, the identifier 204 identifies characteristics associated with the medication. Next, based on the information associated with the medication, the identifier 204 identifies medication interaction information, which may be based, at least in part, on information contained in a patient's medical record and/or history. After the healthcare practitioner has obtained the desired amount of medication, the healthcare practitioner replaces the container and the identifier 204 again identifies the amount of medication in the container. At this point, the identifier 204 identifies if the amount of medication contained in the container is at or below a predetermined level. In some examples, if the identifier 204 identifies that the amount of medication in a container is at or below a predetermined level, this information is retrieved by the processor 210 and an alert may then be conveyed to prompt a healthcare practitioner to reorder the medication. In other examples, the processor 210 may automatically reorder the medication by, for example, conveying the amount and type of medication to a medication provider. In still other examples, the processor 210 may add the medication to a list of medications to be reordered, which may be stored in, for example, the data store 202, the EMR database 133 (FIG. 1) and/or the pharmacy system 106 (FIG. 1).

The medication monitoring unit 124 then conveys the information associated with the medication being administered, along with the associated values to the EMR database 132 for storage, where it can later be retrieved using one of the workstations 112 (FIG. 1). Thus, a healthcare practitioner is able to review the information associated with the identity of the medication being administered and the associated characteristics to verify the accuracy of this information and/or to obtain the most relevant information desired by the healthcare practitioner.

In contrast to known methods and apparatus, the identifier 204 enables healthcare facilities to more accurately monitor the amount of medication in the healthcare facility to ensure adequate quantities are maintained onsite. Additionally, such monitoring more accurately accounts for medications in the healthcare facility to prevent improper usage (e.g., illicit purposes) by individuals that may have access to the medication. Further, identifying characteristics related to the medication being administered, enables healthcare practitioners to easily identify potential problems and/or to review information related to the medication. Once the identifier 204 has identified the amount of medication in the container prior to and after administering the medication and the characteristics associated with the administered medication, the associated values are retrieved by the processor 210 and conveyed to the data store 202 for storage.

To determine an actual amount of medication administered, the processor 210 retrieves the values generated by the identifier 204 from the data store 202 and conveys this information to the analyzer 206. In particular, the analyzer 206 may determine a difference between the amount of medication in the container prior to administering the medication and after administering the medication. Additionally, based on the difference, the analyzer 206 may determine the amount of medication administered to a particular patient. The analyzer 206 may also create a software object to represent the difference between the amount of medication in the container prior to and after the medication is administered, which is associated with the amount of medication administered to the particular patient. Once the analyzer 206 has determined the amount of medication administered, the associated values are retrieved by the processor 210 and conveyed to the data store 202 for storage.

The medication monitoring unit 124 then conveys the information associated with the amount of medication administered, along with the associated values to the EMR database 132 for storage, where it can later be retrieved using one of the workstations 112 (FIG. 1). Thus, a healthcare practitioner is able to review the amount of medication administered to verify the accuracy of this information. The values determined by the analyzer 206 enables healthcare practitioners to accurately monitor and/or verify the amount of medication administered to a patient. In some examples, the analyzer 206 enables healthcare practitioners to verify that the amount of medication administered is the recommended dosage based on, for example, the patient's medical record and/or history and/or the patient's physical characteristics.

To associate information related to administering medication to a patient with the patient's medical report, record and/or history, the processor 210 retrieves the values generated by the analyzer 206 from the data store 202 and conveys this information to the recorder 208. In particular, the recorder 208 may assign a value, which is associated with the patient's medical report, record and/or history to the information associated with administering the medication. This information may indicate that the patient received a particular amount of medication at a particular time. In contrast to known methods, which rely heavily on handwritten notes to monitor when and how much of a particular medication was administered, the recorder 208 enables real-time updating of the patient's medical report, record and/or history. This approach enables healthcare practitioners to more accurately monitor the type of medication(s) administered to a patient along with the dosage and the dosing interval of the particular medication. Such monitoring decreases the likelihood that medications are improperly administered.

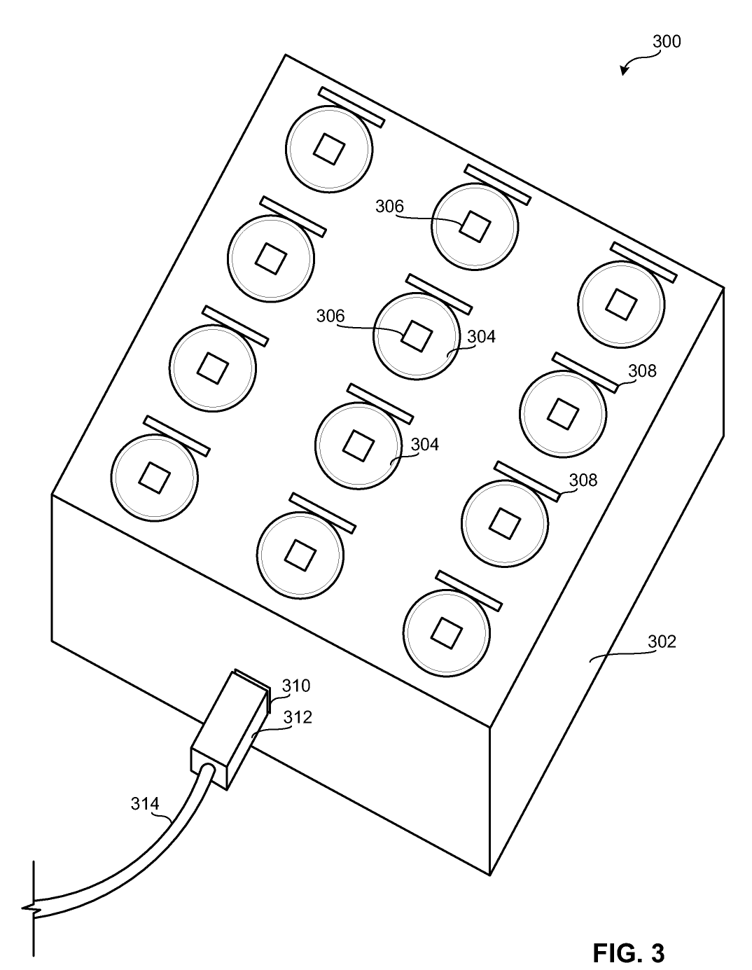

FIG. 3 depicts an example apparatus 300 that may be used to implement the medication monitoring unit(s) 124 of FIG. 1. The example apparatus 300 includes a housing 302 that defines a plurality of slots 304 that are each configured to receive a container that contains medication. While the slots 304 of FIG. 3 are depicted as having substantially the same size and shape, the slots 304 may be different sizes and/or different shapes, which correspond to the size and shape of the different containers containing medication.

A first sensor 306 (e.g., a weight sensor) is disposed in each slot 304. Additionally, in some examples, the slots 304 may each include a second sensor 308 (e.g., a reader or scanner) that may be used to read a barcode located on the containers. However, in other examples, each of the slots 304 may be associated with a particular medication and, thus, the example apparatus 300 may not be provided with the second sensor 308. In other examples, the second sensor 308 may be a reader located toward the bottom of each of the slots 304 that projects, for example, a conical signal or wave, that identifies the presence of an RFID tag located on the respective container. The RIFD tag may contain similar information as contained on the barcode and may be advantageously utilized to locate and/or track the container's whereabouts in a healthcare facility. While the first sensor 306 and the second sensor 308 are depicted separately in FIG. 3, the first sensor 306 and the second sensor 308 may be integrated together. Additionally, the housing 302 defines a port 310 (e.g., a USB port) that is configured to receive a connector 312 to communicatively couple the housing 302 to a processing unit (e.g., the workstation 112 of FIG. 1) via a cord 314. In other examples, the example apparatus 300 may be provided with a transmitter (not shown) to transmit and/or receive information associated with the medication and/or containers positioned in the slots 304.

While the example apparatus 300 is depicted in FIG. 3 as having twelve slots 304, the example apparatus 300 may be provided with any number of slots 304 (e.g., 1, 2, 3, 4, 5, 6, etc.).

In operation, containers containing medication may be positioned in each of the slots 304. The first sensor 306 may weigh the contents of the respective container and then transmit a value associated with the weight of the respective container to, for example, the processor 210 (FIG. 2), the EMR database 132 (FIG. 1) and/or the pharmacy system 106 (FIG. 1). To obtain medication to be administered, initially, a healthcare practitioner removes the desired medication from the respective slot 304. As the healthcare practitioner moves (e.g., removes) the container, the first sensor 306 identifies that the particular container has been moved and transmits this information to, for example, the processor 210 (FIG. 2). The processor 210 (FIG. 2) then initiates the second sensor 308 to obtain information from the container and/or read information contained on the RFID tag. In some examples, the processor 210 initiates the second sensor 308 to read a barcode located on the container. The barcode may contain information associated with an identity of the medication, an intended dosage of the medication, a dosing interval for the medication or medication interaction information.

The example apparatus 300 then conveys the information associated with the medication, along with the associated values to the respective workstations 112 (FIG. 1), the EMR database 132 for storage and/or the pharmacy system 106 (FIG. 1) via the cord 314. Thus, a healthcare practitioner is able to review and/or confirm the identity of the medication, the intended dosage of the medication, the dosing interval for the medication and/or the medication interaction information.

After the medication is obtained, the healthcare practitioner places the container back into the respective slot 304 and the first sensor 306 again may weigh the contents of the respective container and transmit a value associated with the weight of the respective container to the processor 210 (FIG. 2), the EMR database 132 (FIG. 1) and/or the pharmacy system 106 (FIG. 1). As discussed above, the analyzer 206 (FIG. 2) may determine the difference between the medication in the container prior to administering the medication and after administering the medication. This difference is associated with the amount of medication administered to a particular patient.

The example apparatus 300 then conveys the information associated with the amount of medication administered to the respective workstations 112 (FIG. 1), the EMR database 132 (FIG. 1) for storage and/or the pharmacy system 106 (FIG. 1) via the cord 3 14. Thus, a healthcare practitioner is able to review and/or confirm the amount of medication administered. Additionally, if the first sensor 306 identifies that the weight of a container is at or below a predetermined weight, the apparatus 300, for example, conveys this information to prompt a healthcare practitioner to reorder the medication, to automatically reorder the medication and/or to add the medication to a list of medications to be reordered.

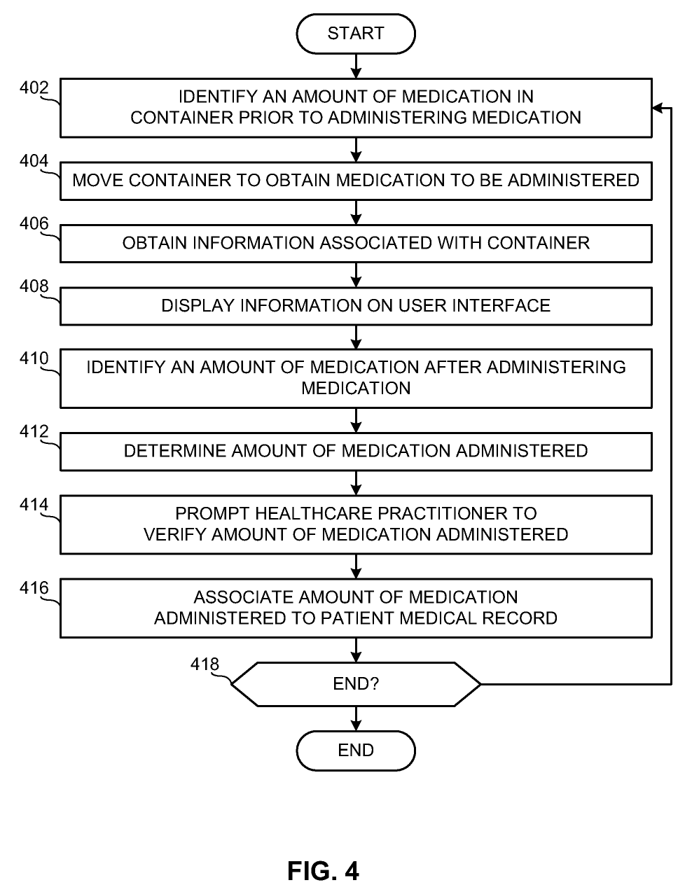

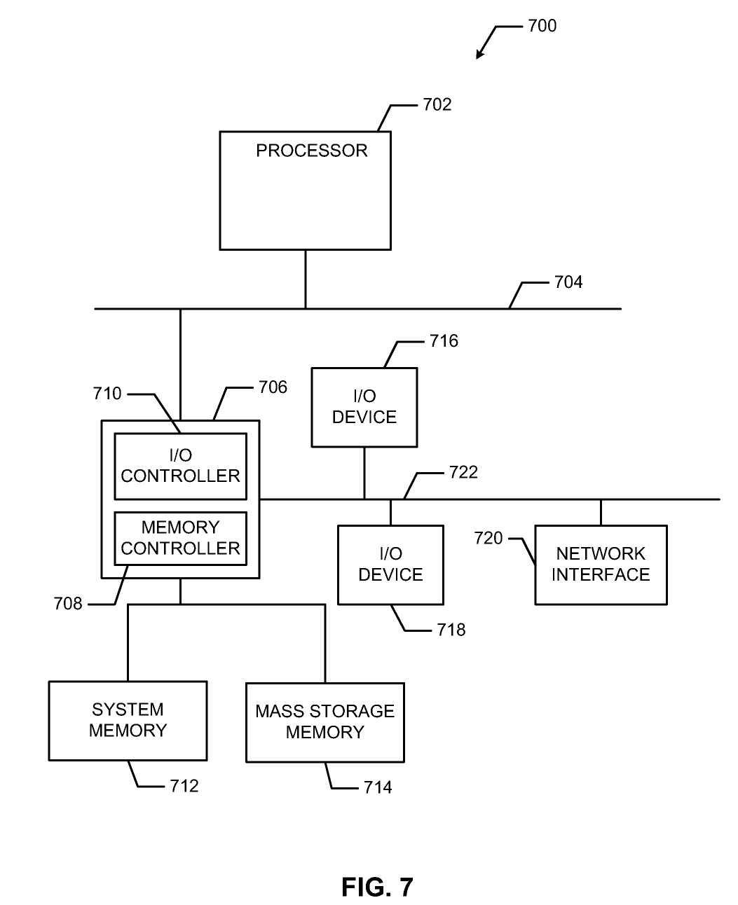

The flow diagrams depicted in FIGS. 4, 5 and 6 are representative of machine readable instructions that can be executed to implement the example methods and apparatus described herein. In particular, FIGS. 4, 5 and 6 depict flow diagrams representative of machine readable instructions that may be executed to implement the example medication monitoring unit 124, the example apparatus 200 and 300 and/or any of the other examples described herein to monitor medication in a healthcare facility. The example processes of FIGS. 4, 5 and 6 may be performed using a processor, a controller and/or any other suitable processing device. For example, the example processes of FIGS. 4, 5 and 6 may be implemented in coded instructions stored on a tangible medium such as a flash memory, a read-only memory (ROM) and/or random-access memory (RAM) associated with a processor (e.g., an example processor system 700 discussed below in connection with FIG. 7). Alternatively, some or all of the example processes of FIGS. 4, 5 and 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 4, 5 and 6 may be implemented manually or as any combination(s) of any of the foregoing techniques, for example, any combination of firmware, software, discrete logic and/or hardware. Further, although the example processes of FIGS. 4, 5 and 6 are described with reference to the flow diagrams of FIGS. 4, 5 and 6 other methods of implementing the processes of FIGS. 4, 5 and 6 may be employed. For example, the order of execution of the blocks may be changed, and/or some of the blocks described may be changed, eliminated, sub-divided, or combined. Additionally, any or all of the example processes of FIGS. 4, 5 and 6 may be performed sequentially and/or in parallel by, for example, separate processing threads, processors, devices, discrete logic, circuits, etc.

Turning to FIG. 4, the identifier 204 (FIG. 2) and/or the first sensor 306 (FIG. 3) identify the amount and/or the weight of medication in a container positioned in, for example, one of the plurality of slots 304 (FIG. 3) prior to the medication being administered (block 402). A healthcare practitioner then removes the container from the respective slot 304 to obtain the medication being administered (block 404). As the container is being moved, the identifier 204 (FIG. 2) and/or the first sensor 306 identify this movement, which initiates the identifier 204 (FIG. 2) and/or the second sensor 308 (FIG. 3) to identify and/or obtain information associated with the respective medication and/or container (block 406). As discussed above, this information may be associated with an identity of the medication, an intended dosage of the medication, a dosing interval for the medication, medication interaction information or any other suitable information.

The processor 210 then retrieves the information related to the medication being administered and conveys this information to the respective workstation 112 where it is displayed on one of the user interfaces 128 (block 408), to the EMR database 132 (FIG. 1) for storage and/or to the pharmacy system 106 (FIG. 1). In some examples, some of the displayed information may be based on the patient's medical record and/or history.

After the medication has been administered, the container is placed back into the respective slot 304 (FIG. 3) and the identifier 204 (FIG. 2) and/or the first sensor 306 (FIG. 3) identify the amount and/or the weight of the medication in the container (block 410). The analyzer 206 (FIG. 2) then determines the difference between the amount of the medication in the container prior to administering the medication and after administering the medication. This difference is associated with the amount of medication administered to a particular patient (block 412).

The processor 210 then retrieves the information related to the amount of medication administered and conveys this information to the respective workstation 112 where it is displayed on one of the user interfaces 128, to the EMR database 132 for storage and/or to the pharmacy system 106 (FIG. 1). The healthcare practitioner is then prompted to review and/or verify the amount of medication administered (block 414). After the administered amount of medication is reviewed and/or verified, the recorder 208 (FIG. 2) associates the time, the amount and/or the type of medication administered with the patient medical record and/or history (block 416).

The processor 210 then determines whether control should return to block 402 (block 418). Otherwise, the example process of FIG. 4 is ended.

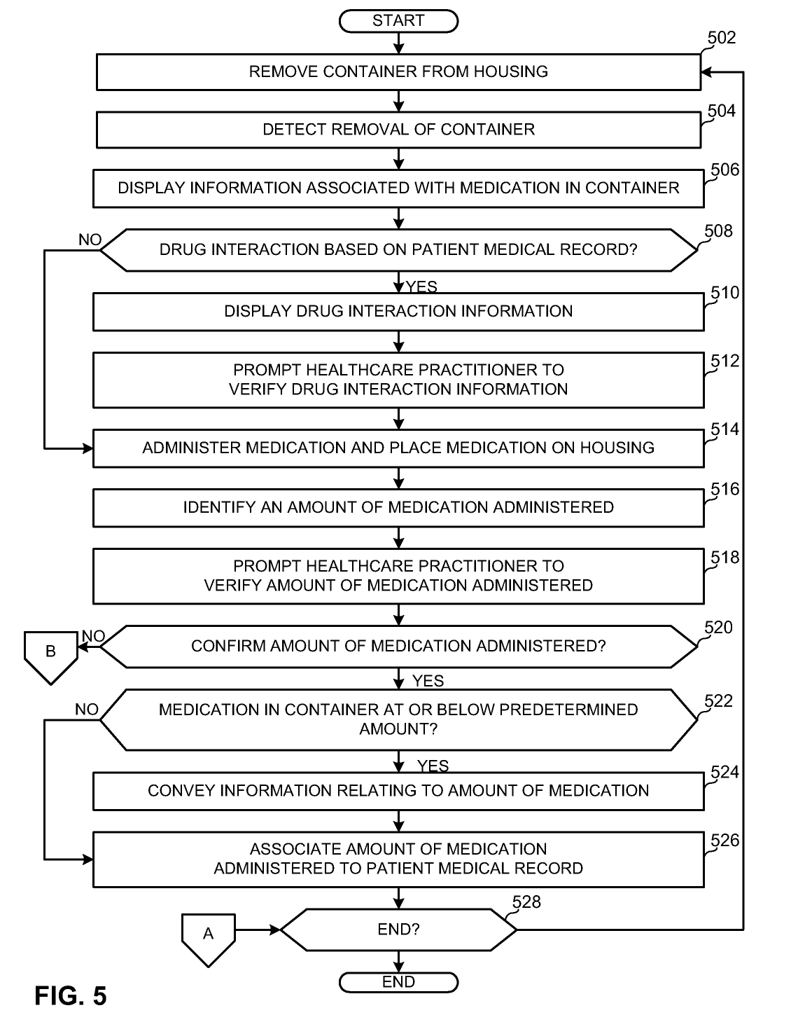

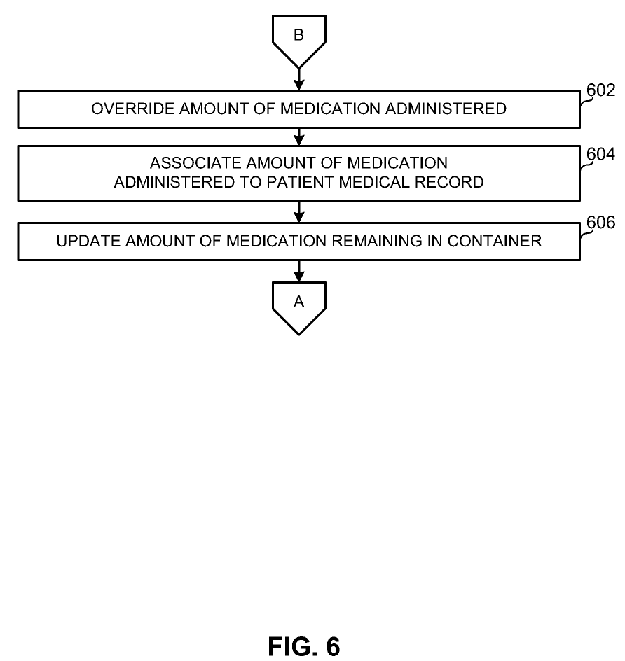

Turning to FIGS. 5 and 6, initially one of the containers positioned in one of the plurality of slots 304 (FIG. 3) of the housing 302 (FIG. 3) is removed (block 502) by, for example, a healthcare practitioner. As the container is being moved, the identifier 204 (FIG. 2) and/or the first sensor 306 detect the removal of the container (block 504) (e.g., movement), which initiates the identifier 204 (FIG. 2) and/or the second sensor 308 (FIG. 3) to identify information associated with the respective medication and/or container. The processor 210 (FIG.2) then retrieves the information related to the medication being administered and conveys this information to the respective workstation 112 where it is displayed on one of the user interfaces 128 (block 506). As discussed above, this information may be associated with an identity of the medication, an intended dosage of the medication, a dosing interval for the medication, medication interaction information or any other suitable information.

The identifier 204 (FIG. 2) and/or the processor 210 (FIG. 2) then determine if there is any drug interaction based, in some examples, on the patient's medical record and/or history (block 508). In particular, the identifier 204 compares the medication to be administered with medications identified in the patient's medical record and/or history to ensure that the patient is not taking other medications that may have adverse affects if combined with the medication to be administered. If the identifier 204 (FIG. 2) and/or the processor 210 (FIG. 2) do not identify any drug interaction information, control moves to block 514.

However, if the identifier 204 identifies drug interaction information, the processor 210 (FIG. 2) then retrieves the information associated with the particular drug interaction and conveys this information to the respective workstation 112 where it is displayed on one of the user interfaces 128 (block 510). The healthcare practitioner is then prompted via, for example, the processor 210 and/or the respective workstation 112, to verify and/or acknowledge the drug interaction information (block 512).

The healthcare practitioner then administers the medication and the container is then placed back into the respective slot 304 (FIG. 3) of the housing 302 (FIG. 3) (block 514). Next, the identifier 204 (FIG. 2) and/or the first sensor 306 (FIG. 3) again identify the amount and/or the weight of the medication in the container and the analyzer 206 (FIG. 2) determines the difference between the amount of the medication in the container prior to administering the medication and after administering the medication. This difference is associated with the amount of medication administered to a particular patient (block 516). The processor 210 (FIG. 2) then retrieves the information related to the amount of medication administered and conveys this information to the respective workstation 112 where it is displayed on one of the user interfaces 128. The healthcare practitioner is then prompted via, for example, the processor 210 and/or the respective workstation 112, to verify and/or acknowledge the amount of medication administered (block 518).

The healthcare practitioner then determines whether or not to confirm the amount of medication administered (block 520). If the healthcare practitioner disagrees with the amount of medication administered, control moves to block 602 of FIG. 6. The healthcare practitioner then overrides the amount of medication administered (block 602) by, for example, editing and/or changing the administered amount of medication displayed on the user interface 128. The recorder 208 (FIG. 2) may then assign a value, which is associated with the patient's medical report, record and/or history, to the information associated with administering the medication (block 604). The information may indicate that the patient received a particular amount of medication at a particular time. Next, the healthcare practitioner updates the amount of medication remaining in the container (block 606) based on the actual amount of medication administered. In some examples, if the healthcare practitioner edits and/or changes the administered amount of medication and/or the remaining amount of medication in the container, the processor 210 (FIG. 2) may assign a value associated with the respective healthcare practitioner to the changes made. Control then returns to block 528 of FIG. 5.

However, if the healthcare practitioner confirms the amount of medication administered, control moves to block 522 of FIG. 5. In particular, the identifier 204 (FIG. 2) and/or the first sensor 306 (FIG. 3) identify if the amount of medication remaining in the container is at or below a predetermined amount (block 522). In some examples, the predetermined amount of medication remaining in the container may be, for example, five milliliters remaining in a thirty milliliter container or a one hundred twenty milliliter container, etc. However, in other examples, the predetermined amount may be any other predetermined amount such as, for example, ten milliliters, eleven milliliters, etc., in any size container. Alternatively, the predetermined amount may be based on the weight of the container. In such examples, the predetermined amount of medication remaining in the container may be, for example, five grams of medication remaining in a container that initially contained fifty grams of medication. Additionally, the predetermined amount may be different depending on the particular medication. For example, a first container may have a predetermined level of three milligrams and a second container may have a predetermined level of ten milligrams. Additionally, a healthcare practitioner may assign and/or change the predetermined level for each container and/or slot 304 depending on, for example, usage requirements. If the amount of medication remaining in the container is not at or below a predetermined amount, control moves to block 526.

However, if the amount of medication remaining in the container is at or below the predetermined amount (e.g., less than five milliliters or five grams, etc.), the information relating to the amount of medication in the container is conveyed (block 524) via the processor 210 (FIG. 2) and/or the workstation 112 (FIG. 1) to, for example, a healthcare practitioner to prompt the healthcare practitioner to reorder the medication. In other examples, the processor 210 (FIG. 2) and/or the workstation 112 (FIG. 1) may automatically reorder the medication by conveying this information to a medication provider. In still other examples, the processor 210 (FIG. 2) and/or the workstation 112 (FIG. 1) may add the medication to a list of medications to be reordered that may be stored in, for example, the data store 202 (FIG. 2), the EMR database 132 (FIG. 1) and/or the pharmacy system 106 (FIG. 1). In this manner, the examples described herein ensure that an adequate supply of medication is maintained at the healthcare facility while reducing the amount of time spent by healthcare practitioners in maintaining such supply.

The recorder 208 (FIG. 2) may then assign a value, which is associated with the patient's medical report, record and/or history, to the information associated with administering the medication (block 526). The information may indicate that the patient received a particular amount of medication at a particular time.

The processor 210 (FIG. 2) then determines whether control should return to block 502 (block 528). Otherwise, the example process of FIG. 5 is ended.

FIG. 7 is a block diagram of the example processor system 700 that may be used to implement the apparatus and methods described herein. As shown in FIG. 7, the processor system 700 includes a processor 702 that is coupled to an interconnection bus 704. The processor 702 may be any suitable processor, processing unit or microprocessor. Although not shown in FIG. 7, the processor system 700 may be a multi-processor system and, thus, may include one or more additional processors that are identical or similar to the processor 702 and that are communicatively coupled to the interconnection bus 704.

The processor 702 of FIG. 7 is coupled to a chipset 706, which includes a memory controller 708 and an input/output (I/O) controller 710. As is well known, a chipset typically provides I/O and memory management functions as well as a plurality of general purpose and/or special purpose registers, timers, etc. that are accessible or used by one or more processors coupled to the chipset 706. The memory controller 708 performs functions that enable the processor 702 (or processors if there are multiple processors) to access a system memory 712 and a mass storage memory 714.

The system memory 712 may include any desired type of volatile and/or non-volatile memory such as, for example, static random access memory (SRAM), dynamic random access memory (DRAM), flash memory, read-only memory (ROM), etc. The mass storage memory 714 may include any desired type of mass storage device including hard disk drives, optical drives, tape storage devices, etc.

The I/O controller 710 performs functions that enable the processor 702 to communicate with peripheral input/output (I/O) devices 716 and 718 and a network interface 720 via an I/O bus 722. The I/O devices 716 and 718 may be any desired type of I/O device such as, for example, a keyboard, a video display or monitor, a mouse, etc. The network interface 720 may be, for example, an Ethernet device, an asynchronous transfer mode (ATM) device, an 802.11 device, a DSL modem, a cable modem, a cellular modem, etc. that enables the processor system 700 to communicate with another processor system.

While the memory controller 708 and the I/O controller 710 are depicted in FIG. 7 as separate blocks within the chipset 706, the functions performed by these blocks may be integrated within a single semiconductor circuit or may be implemented using two or more separate integrated circuits.

Certain example implementations contemplate methods, systems and computer program products on any machine-readable media to implement functionality described above. Certain example implementations may be implemented using an existing computer processor, or by a special purpose computer processor incorporated for this or another purpose or by a hardwired and/or firmware system, for example.

Certain example implementations include computer-readable media for carrying or having computer-executable instructions or data structures stored thereon. Such computer-readable media may be any available media that may be accessed by a general purpose or special purpose computer or other machine with a processor. By way of example, such computer-readable media may include RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

The example methods and apparatus described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The example methods and apparatus described herein may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method to monitor an amount of medication administered, comprising:
automatically identifying an actual amount of the medication in a container prior to administering the medication;
automatically identifying the actual amount of the medication in the container after administering the medication;
determining a difference between the amount of the medication prior to administering the medication and after administering the medication, wherein the difference is associated with the amount of the medication administered to a particular patient; and
associating the amount of the medication administered with a patient medical record.

2. The method as defined in claim 1, further comprising initiating a sensor to obtain information from the container when a healthcare practitioner moves the container.

3. The method as defined in claim 2, further comprising displaying the information on a user interface.

4. The method as defined in claim 2, wherein the sensor comprises a scanner that scans a barcode on the container.

5. The method as defined in claim 2, wherein the information is associated with at least one of an identity of the medication, an intended dosage of the medication, a dosing interval for the medication, or medication interaction information.

6. The method as defined in claim 5, wherein identifying the medication interaction information is based at least in part on the patient medical record.

7. The method as defined in claim 1, further comprising prompting a healthcare practitioner to verify the amount of the medication administered.

8. The method as defined in claim 1, further comprising associating the medication in the container with a particular slot in which the container is positioned.

9. The method as defined in claim 1, further comprising automatically reordering the medication when the amount of the medication in the container is at or below a predetermined amount.

10. The method as defined in claim 1, wherein determining the difference between the amount of the medication prior to administering the medication and after administering the medication comprises weighing the container prior to and after the medication is administered.

11. An apparatus for use with a medical information system to monitor an amount of medication administered, comprising:
a housing defining a plurality of slots that are each to receive a container containing medication;
a first sensor disposed in each of the plurality of slots, wherein the first sensor is associated with determining an amount of medication in the respective container; and
a second sensor adjacent each of the plurality of slots to obtain information associated with the respective container.

12. The apparatus as defined in claim 11, wherein an analyzer is to determine a difference between the amount of medication in the container prior to administering the medication and after administering the medication.

13. The apparatus as defined in claim 12, wherein the difference is to be displayed on a user interface.

14. The apparatus as defined in claim 12, wherein the difference is associated with an amount of medication administered to a particular patient.

15. The apparatus as defined in claim 14, wherein the amount of medication administered is to be associated with a patient medical record.

16. The apparatus as defined in claim 11, wherein the information associated with the respective container is to be displayed on a user interface.

17. The apparatus as defined in claim 11, wherein the plurality of slots have substantially the same dimensions.

18. The apparatus as defined in claim 11, wherein the housing is communicatively coupled to a processing unit.

19. The apparatus as defined in claim 11, wherein the first sensor is a weight sensor.

20. The apparatus as defined in claim 11, wherein the second sensor adjacent each of the plurality of slots is to obtain information associated with the respective container when the container is moved by a healthcare practitioner.

21. The apparatus as defined in claim 11, wherein the first sensor and the second sensor are the same sensor.

22. A medical information system, comprising:
a data store in communication with one or more data entry systems to receive information associated with an amount of medication in each of a plurality of containers; and
an identifier to identify the actual amount of medication in each of the plurality of containers and to identify the medication and characteristics of the medication in each of the plurality of containers.

23. The medical information system as defined in claim 22, wherein the identifier is to identify the amount of medication in a particular container prior to administering the medication and after administering the medication, wherein a difference between the amount of medication in the container prior to administering the medication and after administering the medication is associated with an amount of medication administered to a particular patient.

24. The medical information system as defined in claim 23, further comprising a recorder to associate the amount of medication administered to the particular patient to a patient medical record.

25. The medical information system as defined in claim 23, further comprising one or more workstations in communication with the one or more data entry systems, wherein the workstations implement a user interface to enable a healthcare practitioner to review at least the amount of medication administered and the characteristics and the identify of medication in the particular container.

26. The medical information system as defined in claim 23, wherein the identifier is to identify when the medication in the container is at or below a predetermined amount.

27. The medical information system as defined in claim 26, further comprising a processing unit to prompt a healthcare practitioner to reorder the medication when the medication in the container is identified as being at or below the predetermined amount.

28. The medical information system as defined in claim 26, further comprising a processing unit to automatically reorder the medication when the medication in the container is identified as being at or below the predetermined amount.

29. The medical information system as defined in claim 26, further comprising a processing unit to add the medication to a list of medications to be reordered when the medication in the container is identified as being at or below the predetermined amount.
